(19) United States
(12) Patent Application Publication
(10) Pub. No.: US 2013/0127905 A1
(43) Pub. Date: May 23, 2013

(54) DUAL-SYSTEM DISPLAYING METHOD AND ELECTRIC DEVICE

(71) Applicants: BEIJING LENOVO SOFTWARE LTD., BEIJING (CN); LENOVO (BEIJING) CO., LTD., BEIJING (CN)

(72) Inventors: XUEYUAN ZHANG, BEIJING (CN); QIMING DENG, BEIJING (CN); LEI HONG, BEIJING (CN); ZEZHONG WEN, BEIJING (CN)

(73) Assignees: LENOVO (BEIJING) CO., LTD., BEIJING (CN); BEIJING LENOVO SOFTWARE LTD., BEIJING (CN)

(21) Appl. No.: 13/684,303

(22) Filed: Nov. 23, 2012

(30) Foreign Application Priority Data
Nov. 22, 2011 (CN) 201110374580.7

(51) Int. Cl. G09G 5/12

(52) U.S. Cl. CPC G09G 5/12
USPC 345/629

(57) ABSTRACT

Described is a dual-system displaying method and electric device. The electric device includes a display screen, a first system and a second system. The first system includes a first processor and a first storage, a first operating system is stored in the first storage. The first system includes a second processor and a second storage, a second operating system is stored in the second storage. The method includes receiving a first image output from the first system; receiving a second image output from the second system; acquiring a first display image and a second display image, wherein the first display image is at least part of content of the first image and the second display image is at least part of content of the second image; merging the first display image and the second display image to acquire a merged image; outputting the merged image to the display screen.

This application claims priority to CN 201110374580.7 filed on Nov. 22, 2011, the entire contents of which is incorporated herein by reference.

### TECHNICAL FIELD

The present disclosure relates to an electric technology field, in particular to a dual-system displaying method and electric device.

### BACKGROUND

An electronic device having a Hybrid architecture comprises two systems. Each of the systems possesses its independent processor and operating system. For example, a first system possesses an Intel processor and a Windows operating system, and a second system possesses an Arm processor and an Android operating system.

At present, an electric device can merely display the output of one system on a single logic display screen at one time, and cannot simultaneously display the outputs of two systems on the single logic display screen.

### SUMMARY

On this account, the present disclosure provides a dual-system displaying method and electric device being capable of displaying simultaneously the outputs of two systems on a single logic display screen.

In order to solve the problem mentioned above, the present disclosure provides a dual-system displaying method applied to an electric device, the electric device comprising: a display screen, a first system and a second system. The first system comprises a first processor and a first storage, a first operating system is stored in the first storage. The second system comprises a second processor and a second storage, a second operating system is stored in the second storage, characterized in that the method comprises:
receiving a first image output from the first system;
receiving a second image output from the second system;
acquiring a first display image and a second display image, wherein the first display image is at least part of content of the first image and the second display image is at least part of content of the second image;
merging the first display image and the second display image to obtain a merged image;
outputting the merged image to the display screen to be displayed.

In an example, the step of acquiring a first display image and a second display image comprises:
acquiring a first display position information of the image of the first system on the display screen and a second display position information of the image of the second system on the display screen;
acquiring the first display image in accordance with the first display position information and the first image;
acquiring the second display image in accordance with the second display position information and the second image.

In an example, subsequent to the step of outputting the merged image to the display screen to be displayed, the method further comprises:
receiving a boundary adjustment command;
modifying the first display position information and the second display position information according to the boundary adjustment command.

In an example, the step of acquiring a first display image and a second display image comprises:
acquiring a first start display address of the first image and a second start display address of the second image;
acquiring the first display image from the first image in accordance with the first start display address;
acquiring the second display image from the second image in accordance with the second start display address.

In an example, subsequent to the step of outputting the merged image to the display screen to be displayed, the method further comprises:
receiving a visual range adjustment command;
determining a focus system to which the visual range adjustment command corresponds, the focus system being the first system or the second system;
modifying the start display address of the image output from the focus system in accordance with the visual range adjustment command.

The present disclosure further provides an electric device, comprising: a display screen, a first system and a second system. The first system comprises a first processor and a first storage, a first operating system is stored in the first storage. The second system comprises a second processor and a second storage, a second operating system is stored in the second storage. The electric device further comprises:
a controller for receiving a first image output from the first system and a second image output from the second system; acquiring a first display image and a second display image, wherein the first display image is at least part of content of the first image and the second display image is at least part of content of the second image; merging the first display image and the second display image to obtain a merged image; outputting the merged image to the display screen to be displayed.

In an example, the controller comprises:
a first input module for receiving the first image output from the first system;
a second input module for receiving the second image output from the second system;
an acquiring module for acquiring the first display image and the second display image, wherein the first display image is at least part of content of the first image and the second display image is at least part of content of the second image;
a merging module for merging the first display image and the second display image to obtain a merged image;
an output module for outputting the merged image to the display screen to be displayed.

In an example, the controller further comprises:
a first storing module for storing a first display position information of the image of the first system on the display screen and a second display position information of the image of the second system on the display screen;
the acquiring module comprises:
a first executing module for acquiring the first display position information and the second display position information;
a second executing module for acquiring the first display image in accordance with the first display position information and the first image;
a third executing module for acquiring the second display image in accordance with the second display position information and the second image.

In an example, the controller further comprises:
a first receiving module for receiving a boundary adjustment command;
a first modifying module for modifying the first display position information and the second display position information stored in the first storing module in accordance with the boundary adjustment command.

In an example, the controller further comprises:
a second storing module for storing a first start display address of the first display image in the first image and a second start display address of the second image;
the acquiring module comprises:
the fourth executing module for acquiring the first start display address and the second start display address;
acquiring the first display image from the first image in accordance with the first start display address;
acquiring the second display image from the second image in accordance with the second start display address.

In an example, the controller further comprises:
a second receiving module for receiving a visual range adjustment command;
a focus system determining module for determining a focus system to which the visual range adjustment command corresponds, the focus system being the first system or the second system;
a second modifying module for modifying the start display address of the image output from the focus system stored in the second storing module in accordance with the visual range adjustment command.

In an example, the controller is an embedded controller.

The present disclosure possesses the following advantageous effects:
capable of simultaneously displaying the outputs of two systems on a single logic display screen.
capable of flexibly adjusting boundaries of display images of the two systems according to the requirement.
capable of flexibly adjusting a visual range of the display image of each of the systems according to the requirement.
being realized by the existing embedded controller, with a lower cost.

### BRIEF DESCRIPTION OF THE DRAWINGS

FIG. 1 is a schematic flowchart of a dual-system displaying method of embodiments of the present disclosure;

FIG. 2 is an example of a merged image of the embodiments of the present disclosure;

FIG. 3 is another example of a merged image of the embodiments of the present disclosure;

FIG. 4 is another schematic flowchart of a dual-system displaying method of the embodiments of the present disclosure;

FIGS. 5 and 6 are an example of modifying display positions of images on a display screen of the embodiments of the present disclosure;

FIG. 7 is another schematic flowchart of a dual-system displaying method of the embodiments of the present disclosure;

FIG. 8 is an example of modifying start display addresses of images of the embodiments of the present disclosure;

FIG. 9 is a schematic structure diagram of an electric device of the embodiment of the presents disclosure;

FIG. 10 is another schematic structure diagram of an electric device of the embodiments of the present disclosure.

### DETAILED DESCRIPTION

The particular implementations of the present disclosure will be further described in detail by combining with the accompanying drawings and the embodiments.

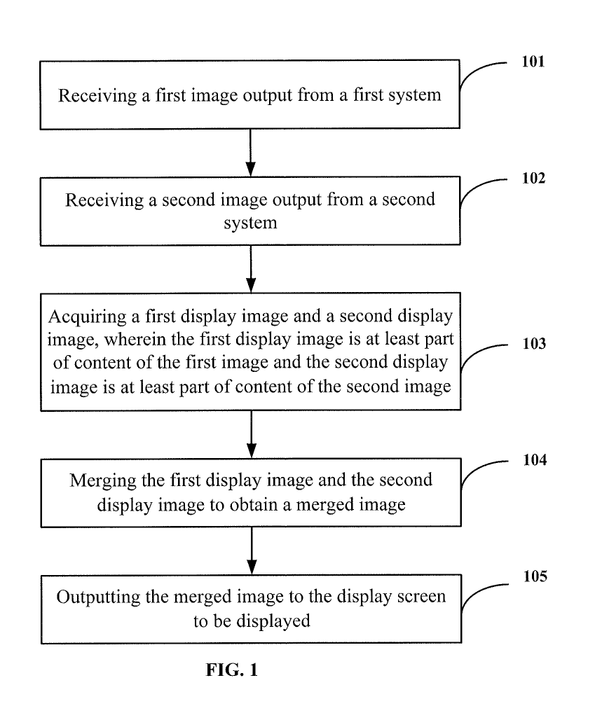

As show in FIG. 1, provided is a schematic flowchart of a dual-system displaying method of the embodiment of the present disclosure. The method is applied to an electric device, the electric device comprises: a display screen, a first system and a second system. The first system comprises a first processor and a first storage, a first operating system is stored in the first storage. The second system comprises a second processor and a second storage, a second operating system is stored in the second storage.

For example, the first processor in the first system may be an Intel processor; the first operation system stored in the first storage may be a Windows operating system; the second processor in the second system may be an Arm processor; the second operating system stored in the second storage may be an Android operating system.

In order to be able to display simultaneously the outputs of the two systems on a single logic display screen, the dual-system displaying method of the embodiment of the present disclosure comprises the following steps:

Step 101, receiving a first image output from the first system;

Step 102, receiving a second image output from the second system;

Step 103, acquiring a first display image and a second display image, wherein the first display image is at least part of content of the first image and the second display image is at least part of content of the second image;

Step 104, merging the first display image and the second display image to obtain a merged image;

Step 105, outputting the merged image to the display screen to be displayed.

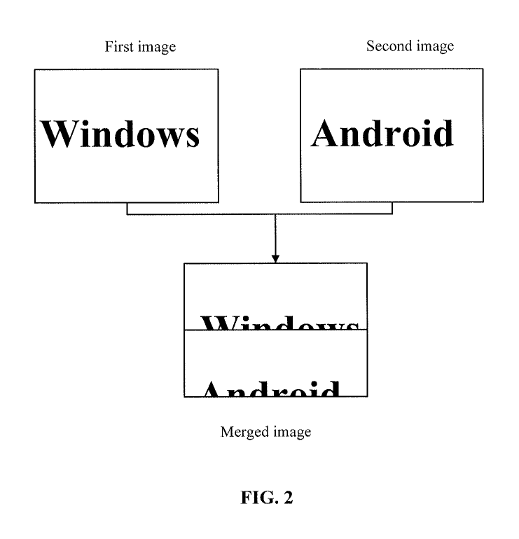

As shown in FIG. 2, when image merging is performed, the resolution of the first image and the resolution of the second image may not be changed, but a part of content is acquired from the first image and a part of content is acquired from the second image, that is, the first display image is a part of content of the first image, and the second display image is a part of content of the second image. Then, the first display image and the second display image are merged to obtain a merged image.

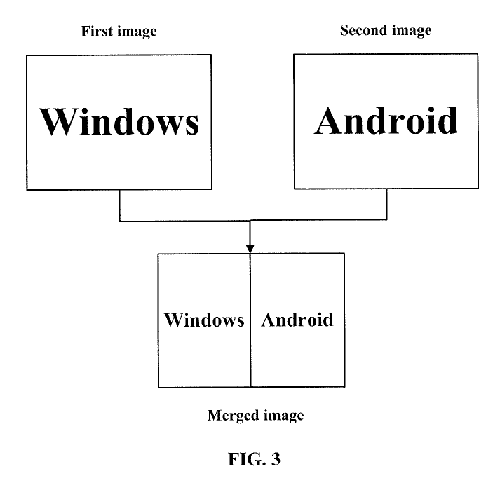

As shown in FIG. 3, when image merging is performed, the resolution of the first image and the resolution of the second image may be changed to scale down the first image and the second image, so that all the content of the first image and the second image can be displayed on the display screen, that is, the first display image is all the content of the first image, and the second display image is all the content of the second image. Then, the first display image and the second display image are merged to obtain a merged image.

In the embodiment described above, the display positions of the images of the first system and the second system on the display screen of the electric device can be preset. As shown in FIG. 2, the image of the first system can be displayed on the upper half part of the display screen and the image of the second system can be displayed on the lower half part of the display screen. Or, as shown in FIG. 3, the image of the first system can be display on the left half part of the display screen and the image of the second system can be displayed on the right half part of the display screen.

In the embodiment as shown in FIGS. 2 and 3, displaying the images of the first system and the second system in an upper-lower halving or left-right halving display proportion is taken for an instance. However, the displaying method of the embodiment of the present disclosure is not limited thereto, and can also perform displaying in other display proportions. For example, the image of the first system can be displayed on the upper ⅔ part of the display screen, and the image of the second system can be displayed on the lower ⅓ part of the display screen.

In the embodiment of the present disclosure, the electric device can store the preset display position information of the images of the first system and the second system on the display screen and acquire the first display image and the second display image in accordance with the display position information. In addition, the display position information can be modified according to the requirement.

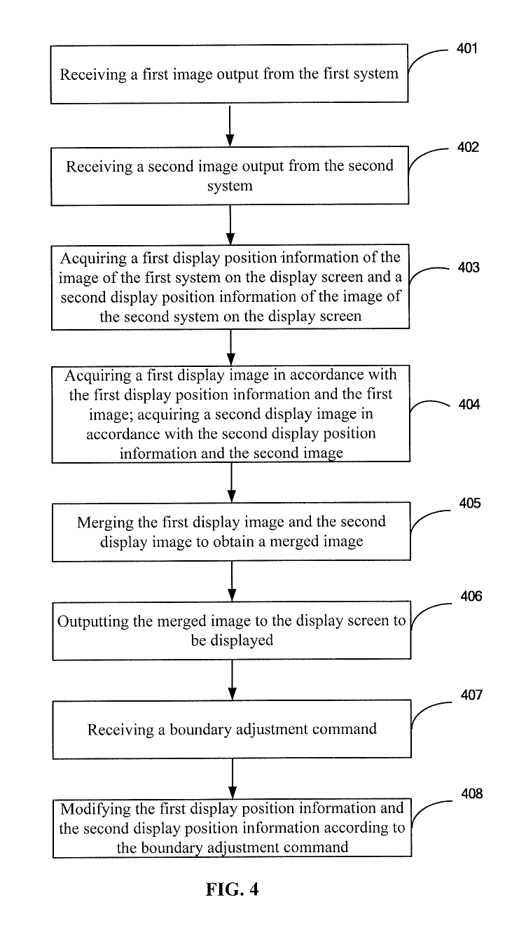

As shown in FIG. 4, provided is another schematic flowchart of the dual-system displaying method of the embodiment of the present disclosure. The method is applied to an electric device, the electric device comprises: a display screen, a first system and a second system. The first system comprises a first processor and a first storage, a first operating system is stored in the first storage. The second system comprises a second processor and a second storage, a second operating system is stored in the second storage.

The method comprises the following steps:

Step 401, receiving a first image output from the first system;

Step 402, receiving a second image output from the second system;

Step 403, acquiring a first display position information of the image of the first system on the display screen and a second display position information of the image of the second system on the display screen;

Step 404, acquiring a first display image in accordance with the first display position information and the first image, and acquiring a second display image in accordance with the second display position information and the second image.

Step 405, merging the first display image and the second display image to obtain a merged image;

Step 406, outputting the merged image to the display screen to be displayed.

Step 407, receiving a boundary adjustment command;

Step 408, modifying the first display position information and the second display position information according to the boundary adjustment command.

After that, repeating the execution of the steps 401˜406, the electric device acquires a new first display image and a new second display image in accordance with the modified first display position information and second display position information, merges the new first display image and the new second display image to obtain a new merged image, and outputs the new merged image to the display screen to be displayed.

The boundary adjustment command can be produced by a variety of modes. Below is a specification in detail.

(1) Produced by Pressing a Shortcut Key

For example, supposing that in the merged image, the first display image is placed in the upper half part and the second display image is placed in the lower half part, pressing the shortcut key Ctrl+PgUp indicates that it is required to shift up the boundary between the first display image and the second display image, and pressing the shortcut key Ctrl+PgDn indicates that it is required to shift down the boundary between the first display image and the second display image. As for the distance for shifting up or down, it may also be set according to the requirement, for example, shifting up 50 pixels for each pressing of the shortcut key Ctrl+PgUp.

(2) Produced by Dragging a Mouse

In the embodiment of the present disclosure, a boundary zone can be generated between the first display image and the second display image. When a cursor is left in the boundary zone, it can be dragged up and down or left and right so as to adjust the boundary between the first display image and the second display image.

In addition, the boundary adjustment command can also be produced by other modes, for example, setting a boundary adjustment button on the electric device and thus adjusting the boundary through pressing the button, or adjusting the boundary through inputting a command, etc.

Below will be a specification for the above-mentioned dual-system displaying method by an example.

Supposing that the resolutions of the display screen, the first image and the second image are all 1280×800; the preset first display position of the image of the first system on the display screen is 0˜399 rows, and the preset second display position of the image of the second system on the display screen is 400˜799 rows, i.e., displaying in an upper-lower halving display proportion.

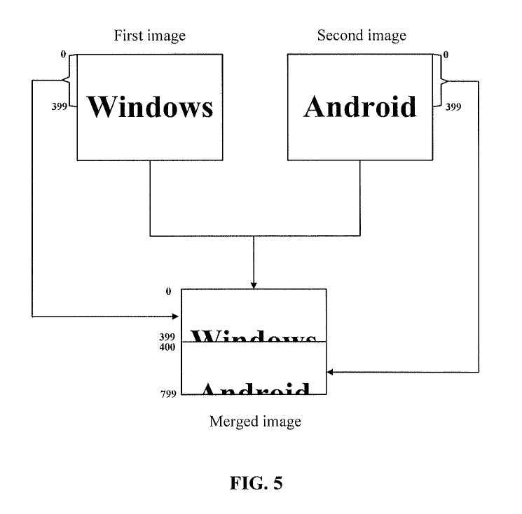

As shown in FIG. 5, the electric device can acquire 0˜399 rows of the first image in accordance with the first display position information to obtain a first display image; acquire 0˜399 rows of the second image in accordance with the second display position information to obtain a second display image, and then merge the first display image and the second display image to obtain a merged image and display the merged image.

When receiving a boundary adjustment command, the electric device can modify the first display position information and the second display position information in accordance with the boundary adjustment command. Supposing that the boundary adjustment command is produced by a pressing the shortcut key Ctrl+PgUp by a user and 50 pixels are shifted up for each pressing of the shortcut key Ctrl+PgUp, and supposing that the user has pressed the shortcut key Ctrl+PgUp for two times, the electric device at this time modifies the first display position information as 0˜299 rows and modifies the second display position information as 300˜799 rows.

As shown in FIG. 6, the electric device can acquire 0˜299 rows of the first image in accordance with the new first display position information to obtain a new first display image; acquire 0˜499 rows of the second image in accordance with the new second display position information to obtain a new second display image, and then merge the new first display image and the new second display image to obtain a new merged image and display the new merged image.

In the embodiment as shown in FIGS. 5 and 6, when the electric device acquires the first display image (or acquires the second display image), the acquiring is performed from the 0^{th} row of the first image (or the second image). The embodiment of the present disclosure merely takes it for an example and does not limit thereto, for the acquiring can also performed from other positions of the first image (or the second image), for example, from the 350^{th} row of the first image, etc.

Further, when the first display image and the second display image displayed on the display screen are just a part of content of the images output from the first system and the second system, the user may also adjust the visual range of the first display image and the second display image displayed on the display screen according to the requirement.

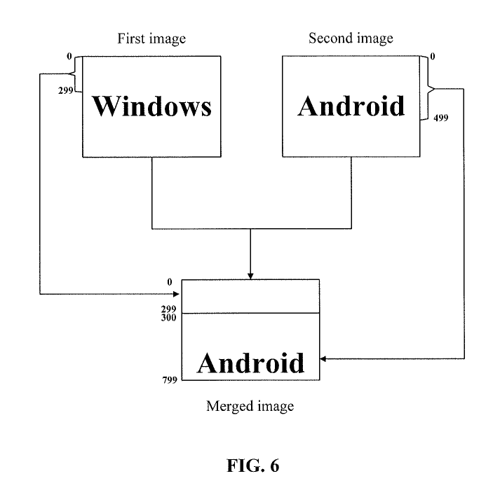

As shown in FIG. 7, provided is another schematic flowchart of the dual-system displaying method of the embodiment of the present embodiment. The method is applied to an electric device. The electric device comprises: a display screen, a first system and a second system. The first system comprises a first processor and a first storage, a first operating system is stored in the first storage. The second system comprises a second processor and a second storage, a second operating system is stored in the second storage.

The method comprises the following steps:

Step 701, receiving a first image output from the first system;

Step 702, receiving a second image output from the second system;

Step 703, acquiring a first start display address of the first image and a second start display address of the second image;

Step 704, acquiring the first display image from the first image in accordance with the first start display address, and acquiring the second display image from the second image in accordance with the second start display address;

Step 705, merging the first display image and the second display image to obtain a merged image;

Step 706, outputting the merged image to the display screen to be displayed;

Step 707, receiving a visual range adjustment command;

Step 708, determining a focus system to which the visual range adjustment command corresponds, and modifying the start display address of the image output from the focus system in accordance with the visual range adjustment command, the focus system being the first system or the second system.

The so-called focus system refers to the system in an editing state currently.

The visual range adjustment command can be produced by a variety of modes. Below is a specification by an example.

(1) Produced by Pressing a Shortcut Key

For example, supposing that in the merged image, the first display image is placed in the upper half part and the second display image is placed in the lower half part, pressing the shortcut key Ctrl+PgUp indicates that it is required to scroll up the first display image and pressing the shortcut key Ctrl+PgDn indicates that it is required to scroll down the first display image. As for the distance for scrolling up or down, it may also be set according to the requirement, for example, scrolling up 30 pixels for each pressing of the shortcut key Ctrl+PgUp.

(2) Produced by Dragging a Mouse

For example, the focus system is the first system, and the first display image is scrolled by dragging up or down the screen.

In addition, the visual range adjustment command can also be produced by other modes, for example, setting a visual range adjustment button on the electric device and thus adjusting the visual range of the first display image or the second display image through pressing the button, or adjusting the visual range of the first display image or the second display image through inputting a command, etc.

Below will be a specification for the above-mentioned dual-system displaying method by an example.

Supposing that the resolutions of the display screen, the first image and the second image is 1280×800; the preset first display position of the image of the first system on the display screen is 0˜399 rows, and the preset second display position of the image of the second system on the display screen is 400˜799 rows, i.e., displaying in an upper-lower halving display proportion. The preset first start display address of the first image is the 0^{the} row, and the preset second start display address of the second image is also the 0^{th} row.

As shown in FIG. 5, the electric device can start from the 0^{th} row of the first image and acquire the 0^{th}˜399^{th} rows of data to obtain a first display image; likewise, the electric device can start from the 0^{th} row of the second image and acquire the 0^{th}˜399^{th} rows of data to obtain a second display image, and then merge the first display image and the second display image to obtain a merged image and display the merged image.

When receiving a visual range adjustment command, the electric device firstly determines the focus system to which the visual range adjustment command corresponds, supposing the focus system being the first system. Then, the electric device modifies the first start display address of the first image in accordance with the visual range adjustment command. Supposing that the visual range adjustment command is produced by dragging a screen through a mouse by a user and 100 pixels are dragged down, the electric device at this time modifies the first start display position of the first image as the 100^{th} row.

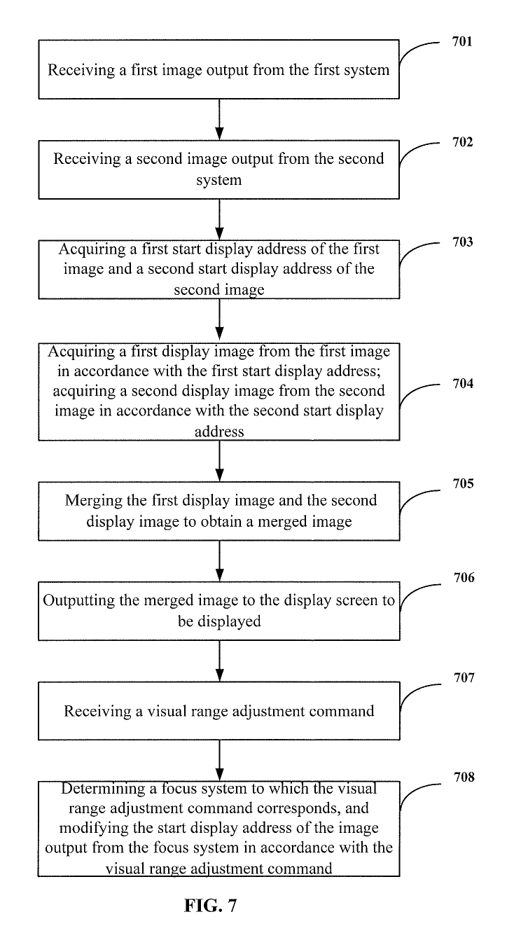

As shown in FIG. 8, the electric device can start from the 100^{th} row of the first image and acquire the 100^{th}˜499^{th} rows of data in accordance with the new first start display address to obtain a new first display image, and then merge the new first display image and the second display image to obtain a new merged image and display the new merged image.

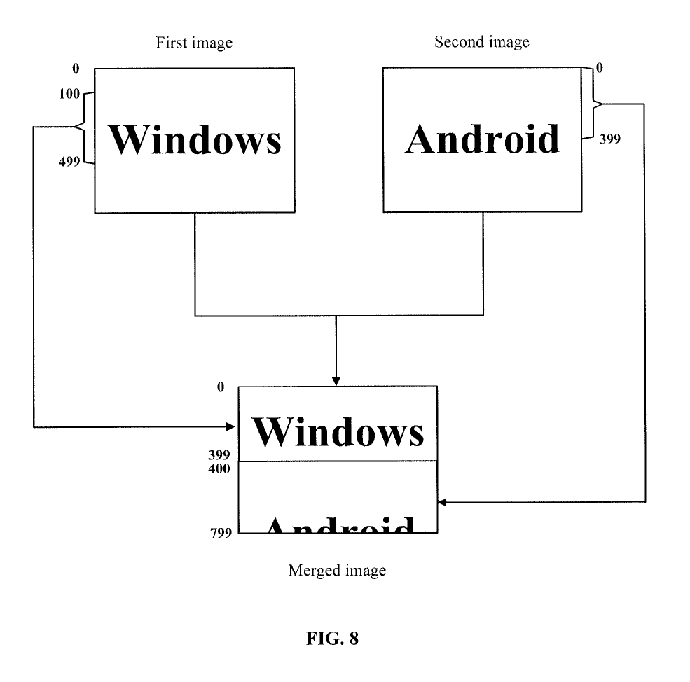

As shown in FIG. 9, the embodiment of the present disclosure further provides an electric device. The electric device comprises: a display screen 901, a first system 902, a second system 903 and a controller 904.

The first system 902 comprises a first processor 9021 and a first storage 9022, a first operating system is stored in the first storage 9022.

The first system 903 comprises a second processor 9031 and a second storage 9032, a second operating system is stored in the second storage 9032.

The controller 904 is used for receiving a first image output from the first system 902 and a second image output from the second system 903; acquiring a first display image and a second display image, wherein the first display image is at least part of content of the first image and the second display image is at least part of content of the second image; merging the first display image and the second display image to obtain a merged image; outputting the merged image to the display screen 901 to be displayed.

The controller 904 may comprise the following functional modules:
a first input module for receiving the first image output from the first system;
a second input module for receiving the second image output from the second system;
an acquiring module for acquiring the first display image and the second display image, wherein the first display image is at least part of content of the first image and the second display image is at least part of content of the second image;
a merging module for merging the first display image and the second display image to obtain the merged image;
an output module for outputting the merged image to the display screen to be displayed.

In the embodiment of the present disclosure, the display positions of the images of the first system and the second system on the display screen of the electric device can be preset. The electric device can store the preset display position information of the images of the first system and the second system on the display screen and acquire the first display image and the second display image in accordance with the display position information. Further, the display position information can be modified according to the requirement.

Based on the above description, the controller in the embodiment of the present disclosure can further comprise:
a first storing module for storing a first display position information of the image of the first system on the display screen and a second display position information of the image of the second system on the display screen;
the acquiring module comprises:
a first executing module for acquiring the first display position information and the second display position information;
a second executing module for acquiring the first display image in accordance with the first display position information and the first image;
a third executing module for acquiring the second display image in accordance with the second display position information and the second image.
a first receiving module for receiving a boundary adjustment command;
a first modifying module for modifying the first display position information and the second display position information stored in the first storing module in accordance with the boundary adjustment command.

In the embodiment of the present disclosure, when the electric device acquires the first display image (or acquires the second display image), it can acquire data from any position of the first image (or the second image), for example, from the 0^{th} row of the first image, etc. Further, when the first display image and the second display image displayed on the display screen are merely a part of content of the images output from the first system and the second system, the user may also adjust the visual range of the first display image and the second display image displayed on the display screen according to the requirement.

Based on the above description, the controller in the embodiment of the present disclosure can further comprise:
a second storing module for storing a first start display address of the first display image in the first image and a second start display address of the second image.
the acquiring module comprises:
a fourth executing module for acquiring the first start display address and the second start display address, acquiring the first display image from the first image in accordance with the first start display address, and acquiring the second display image from the second image in accordance with the second start display address.

The controller can further comprise:
a second receiving module for receiving a visual range adjustment command;
a focus system determining module for determining a focus system to which the visual range adjustment command corresponds, the focus system being the first system or the second system;
a second modifying module for modifying the start display address of the image output from the focus system stored in the second storing module in accordance with the visual range adjustment command.

The controller in the embodiment described above can be realized by an embedded controller (EC). Since the display of the first system and the second system is realized by an EC in the dual-system electric device in the prior art, in the present embodiment, it neither needs to add any new means nor needs to make much modification to the electric device, so as to make the cost lower.

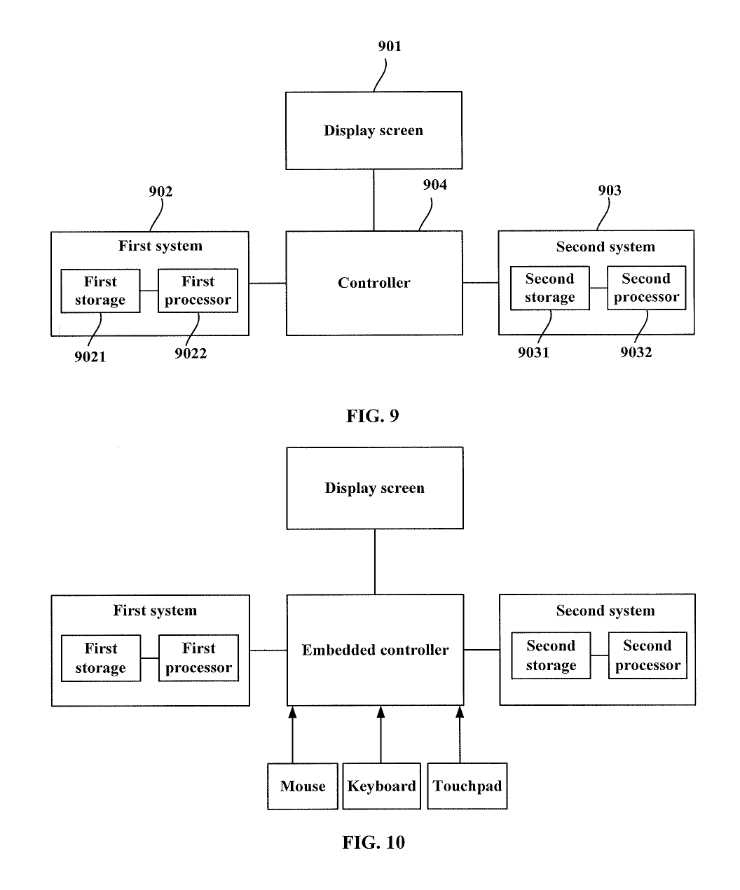

Further, as shown in FIG. 10, the embedded controller is also used for receiving input from the input devices like mouse, touchpad and/or keyboard and so on and transmitting the input from the input devices to the current focus system.

Many functional means as described in the present description are named as modules, so as to more particularly emphasize the independency of its implementation mode.

In the embodiments of the present disclosure, a module can be realized in software, so as to be executed by a variety of processors. For example, an identified executable code module can comprise one or more physical or logical blocks of a computer instruction. For example, it can be constructed as an object, a process or a function. In spite of that, the executable code of the identified module does not need to be physically placed together, but can comprise different instructions stored in different positions. When these instructions are logically combined together, they form a module and realize the prescribed purpose of the module.

As a matter of fact, the executable code module can be a single instruction or a plurality of instructions, and even can be distributed on a plurality of different code segments, be distributed in different programs, and be distributed across a plurality of storages. Likewise, operation data can be identified inside the module, can be realized according to any appropriate form, and can be organized within any appropriate type of data structure. The operation data can be collected as a signal data set, or can be distributed on different positions (including on different storage devices), and can at least partially exist on a system or a network merely as an electric signal.

When the module can be realized in software, in consideration of the existing level of hardware techniques, the module thus can be realized in hardware. Under the condition of taking no account of the cost, those skilled in the art can establish a corresponding hardware circuit to realize the corresponding function. The hardware circuit comprises a conventional very large scale integration (VLSI) circuit or a gate array, and the semiconductor devices in existence such as logic chip and transistor and the like or other discrete elements. The module can also be realized by programmable hardware devices, such as field programmable gate array, programmable array logic and programmable logical devices, etc.

The above described are just preferable embodiments of the present disclosure. It should be pointed out that, for those skilled in the art, many modifications, combinations or sub-combinations can be made without departing from the principle and scope of the present disclosure, and such modifications, combinations or sub-combinations should be considered as falling into the scope of the present disclosure.

What is claimed is:

1. A dual-system displaying method applied to an electric device comprising a display screen, a first system comprising a first processor and a first storage having a first operating system stored therein and a second system comprising a second processor and a second storage having a second operating system stored therein, comprising:
receiving a first image output from the first system;
receiving a second image output from the second system;
acquiring a first display image and a second display image, wherein the first display image is at least part of content of the first image and the second display image is at least part of content of the second image;
merging the first display image and the second display image to obtain a merged image;
outputting the merged image to the display screen to be displayed.

2. The dual-system displaying method as claimed in claim 1, wherein the step of acquiring the first display image and the second display image comprises:
acquiring a first display position information of the image of the first system on the display screen and a second display position information of the image of the second system on the display screen;
acquiring the first display image in accordance with the first display position information and the first image;
acquiring the second display image in accordance with the second display position information and the second image.

3. The dual-system displaying method as claimed in claim 2, further comprises: subsequent to the step of outputting the merged image to the display screen to be displayed,
receiving a boundary adjustment command;
modifying the first display position information and the second display position information according to the boundary adjustment command.

4. The dual-system displaying method as claimed in claim 1, wherein the step of acquiring the first display image and the second display image comprises:
acquiring a first start display address of the first image and a second start display address of the second image;
acquiring the first display image from the first image in accordance with the first start display address;
acquiring the second display image from the second image in accordance with the second start display address.

5. The dual-system displaying method as claimed in claim 4, further comprises: subsequent to the step of outputting the merged image to the display screen to be displayed,
receiving a visual range adjustment command;
determining a focus system to which the visual range adjustment command corresponds, the focus system being the first system or the second system;
modifying the start display address of the image output from the focus system in accordance with the visual range adjustment command.

6. An electric device that includes a display screen, a first system including a first processor and a first storage having a first operating system stored therein and a second system including a second processor and a second storage having a second operating system stored therein, the device comprising:
a controller for receiving a first image output from the first system and a second image output from the second system; acquiring a first display image and a second display image, wherein the first display image is at least part of content of the first image and the second display image is at least part of content of the second image; merging the first display image and the second display image to obtain a merged image; outputting the merged image to the display screen to be displayed.

7. The electric device as claimed in claim 6, wherein the controller comprises:
a first input module for receiving the first image output from the first system;
a second input module for receiving the second image output from the second system;
an acquiring module for acquiring the first display image and the second display image, wherein the first display image is at least part of content of the first image and the second display image is at least part of content of the second image;
a merging module for merging the first display image and the second display image to obtain the merged image;
an output module for outputting the merged image to the display screen to be displayed.

8. The electric device as claimed in claim 7, wherein the controller further comprises: a first storing module for storing a first display position information of the image of the first system on the display screen and a second display position information of the image of the second system on the display screen;
the acquiring module comprises:
a first executing module for acquiring the first display position information and the second display position information;
a second executing module for acquiring the first display image in accordance with the first display position information and the first image;
a third executing module for acquiring the second display image in accordance with the second display position information and the second image.

9. The electric device as claimed in claim 8, wherein the controller further comprises:
a first receiving module for receiving a boundary adjustment command;
a first modifying module for modifying the first display position information and the second display position information stored in the first storing module in accordance with the boundary adjustment command.

10. The electric device as claimed in claim 7, wherein the controller further comprises:
a second storing module for storing a first start display address of the first display image in the first image and a second start display address of the second image;
the acquiring module comprises:
the fourth executing module for acquiring the first start display address and the second start display address, acquiring the first display image from the first image in accordance with the first start display address, and acquiring the second display image from the second image in accordance with the second start display address.

11. The electric device as claimed in claim 10, wherein the controller further comprises:
a second receiving module for receiving a visual range adjustment command;
a focus system determining module for determining a focus system to which the visual range adjustment command corresponds, the focus system being the first system or the second system;
a second modifying module for modifying the start display address of the image output from the focus system stored in the second storing module in accordance with the visual range adjustment command.

12. The electric device as claimed in claim 6, wherein the controller is an embedded controller.
